(19) United States
(12) Patent Application Publication
(10) Pub. No.: US 2018/0286156 A1
(43) Pub. Date: Oct. 4, 2018

(54) TERMINAL DEVICE AND GATE MANAGEMENT SYSTEM

(71) Applicant: FUJITSU LIMITED, Kawasaki-shi (JP)

(72) Inventors: MAHO TAMAI, Nagano (JP); Hideo Haraguchi, Koshigaya (JP)

(73) Assignee: FUJITSU LIMITED, Kawasaki-shi (JP)

(21) Appl. No.: 15/921,728

(22) Filed: Mar. 15, 2018

(30) Foreign Application Priority Data
Mar. 31, 2017 (JP) 2017-073127

(51) Int. Cl. G07C 9/00

(52) U.S. Cl. CPC G07C 9/00087; G07C 9/00111; G07C 2209/08; G07C 2009/00095; G07C 2209/63; G07C 9/00103

(57) ABSTRACT

A terminal device executes a biometric authentication process. The terminal device includes: a memory; and a processor coupled to the memory and configured to: activate the biometric authentication process when the terminal device is detected to approach a predetermined entering/leaving management device; and output authentication information readable by the predetermined entering/leaving management device when the biometric authentication process is determined to be successful.

### CROSS-REFERENCE TO RELATED APPLICATION

This application is based upon and claims the benefit of priority of the prior Japanese Patent Application No. 2017-073127, filed on Mar. 31, 2017, the entire contents of which are incorporated herein by reference.

### FIELD

The embodiments discussed herein are related to a terminal device, a computer-readable recording medium having stored therein a gate management program, and a gate management system.

### BACKGROUND

There has been known a technology using a terminal device for an authentication process for management of entering/leaving a data center or the like. For example, there has been known a technology which causes an entry application management application of a mobile phone to execute an authentication information registration function to transmit individual information including a fingerprint image to an entering/leaving management server, and an entry application request function to transmit entry application information to the entering/leaving management server. In these technologies, when a manager approves the entry, the entering/leaving management server transmits entry application approval information and entry guidance information to the mobile phone, briefly determines the registered fingerprint image and scanned fingerprint data, and provisionally registers the scanned fingerprint data. Further, in the technologies, the entering/leaving management server controls an opening/closing of a gate in the manner that the mobile phone touches over a recognition unit of a gate of a route reaching a visiting section.

Related technologies are disclosed in, for example, Japanese Laid-Open Patent Publication No. 2014-214556.

### SUMMARY

According to an aspect of the embodiments, provided is a terminal device that executes a biometric authentication process. The terminal device includes: a memory; and a processor coupled to the memory and configured to: activate the biometric authentication process when the terminal device is detected to approach a predetermined entering/leaving management device; and output authentication information readable by the predetermined entering/leaving management device when the biometric authentication process is determined to be successful.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of a data center according to Embodiment 1;

FIG. 2 is a diagram illustrating an example of a gate management system according to Embodiment 1;

FIG. 3 is a diagram illustrating an example of screen shift of a terminal device according to Embodiment 1;

FIG. 4 is a diagram illustrating an example of a terminal device according to Embodiment 1;

FIG. 5 is a view illustrating an example of an entry information storage unit according to Embodiment 1;

FIG. 6 is a diagram illustrating an example of a gate management server according to Embodiment 1;

FIG. 7 is a view illustrating an example of a visitor information storage unit according to Embodiment 1;

FIG. 8 is a flowchart illustrating an example of an entry registration process by the terminal device according to Embodiment 1;

FIG. 9 is a flowchart illustrating an example of an entry registration process by the gate management server according to Embodiment 1;

FIG. 10 is a flowchart illustrating an example of an entry authentication process by the terminal device according to Embodiment 1; and

FIG. 11 is a diagram illustrating an example of a hardware configuration of a computer.

### DESCRIPTION OF EMBODIMENTS

In the technologies described above, an individual recognition device using a biometric authentication technique of authenticating an individual based on physical characteristics such as fingerprints is installed in a plurality of gates. However, costs for installing the individual recognition device are high, and especially, costs for a data center or the like where many gates are to be provided are high. Further, since the individual recognition device depends on physical characteristics, costs for replacing the individual recognition device itself is also high when attempting to adopt the biometric authentication technique based on other physical characteristics.

Hereinafter, embodiments of the terminal device, the gate management method, the computer-readable recording medium having stored therein the gate management program, and the gate management system according to the present disclosure will be described in detail based on the accompanying drawings. The present disclosure is not limited by the embodiments. In addition, the embodiments described below may be appropriately combined with each other within a scope that does not cause inconsistency.

### Embodiment 1

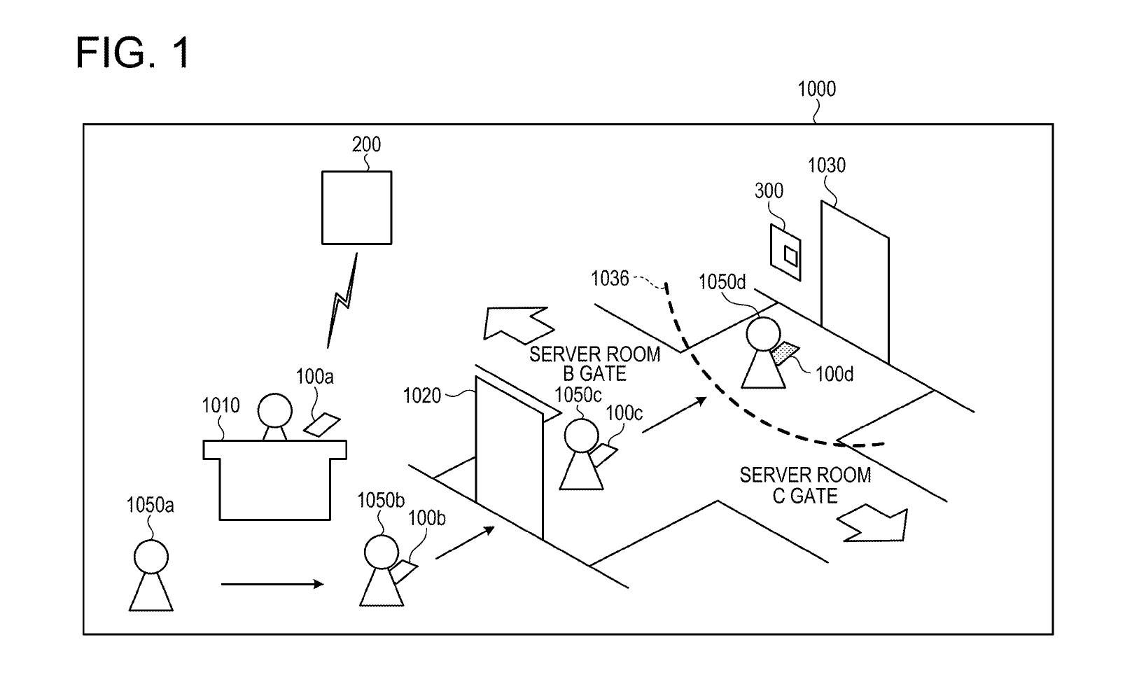

According to the present embodiment, a gate management system 1 is used in a place (e.g., a data center) where entering/leaving authority is determined for each area. Descriptions will be made on user's entry into a server room using the gate management system 1 according to the present embodiment, with reference to FIGS. 1 to 3.

FIG. 1 is a view illustrating an example of a data center according to Embodiment 1. In FIG. 1, a user 1050 of a data center 1000 borrows a terminal device 100 such as a smartphone or a mobile phone from a reception 1010 of the data center 1000. In FIG. 1, users 1050a to 1050d indicate positions of the same user 1050 at different timings, and terminal devices 100a to 100d also indicate positions of the same terminal device 100 at different timings.

In the present embodiment, it is assumed that the user 1050 completes an entry procedure for entering the data center 1000 in advance, and at that time, registers biometric information such as the fingerprints or the iris. Further, it is assumed that entry information of the user 1050 which includes the biometric information is registered in a gate management server 200 at the time of the entry procedure.

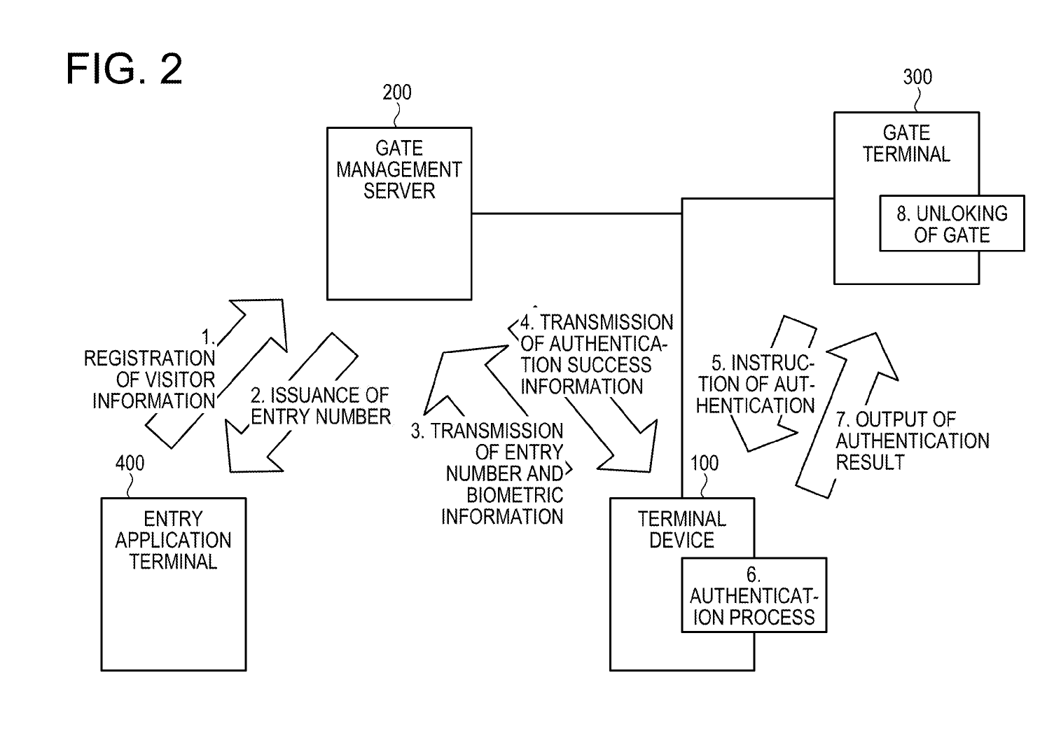

FIG. 2 is a diagram illustrating an example of the gate management system according to Embodiment 1. As illustrated in FIG. 2, the gate management system 1 according to the present embodiment includes the terminal device 100, the gate management server 200, a gate terminal 300, and an entry application terminal 400. The gate terminal 300 is installed at each of, for example, gates 1020 and 1030 in the data center 1000. The gate terminal 300 unlocks the gate by reading an authentication code such as QR code (registered trademark). In addition, the entry application terminal 400 is a computer different from the terminal device 100 and is, for example, a computer installed in the reception 1010 of the data center 1000 or a computer owned by the user 1050.

First, the gate management server 200 receives the information about the visitor in advance from the entry application terminal 400 and registers the information (<1. Registration of Visitor Information> in FIG. 2). As described later, the information about the visitor may be a visitor identifier (ID) for identifying the visitor, scheduled entering/leaving time and others. Further, the gate management server 200 registers the biometric information of the visitor such as the fingerprints, the voiceprints, the iris pattern, or the vein pattern, as the information about the visitor. Then, the gate management server 200 issues an entry number (hereinafter, may be referred to as “Entry No.”) for uniquely identifying an entry schedule of the visitor, and stores the entry number while transmitting the entry number to the entry application terminal 400 (<2. Issuance of Entry Number> in FIG. 2).

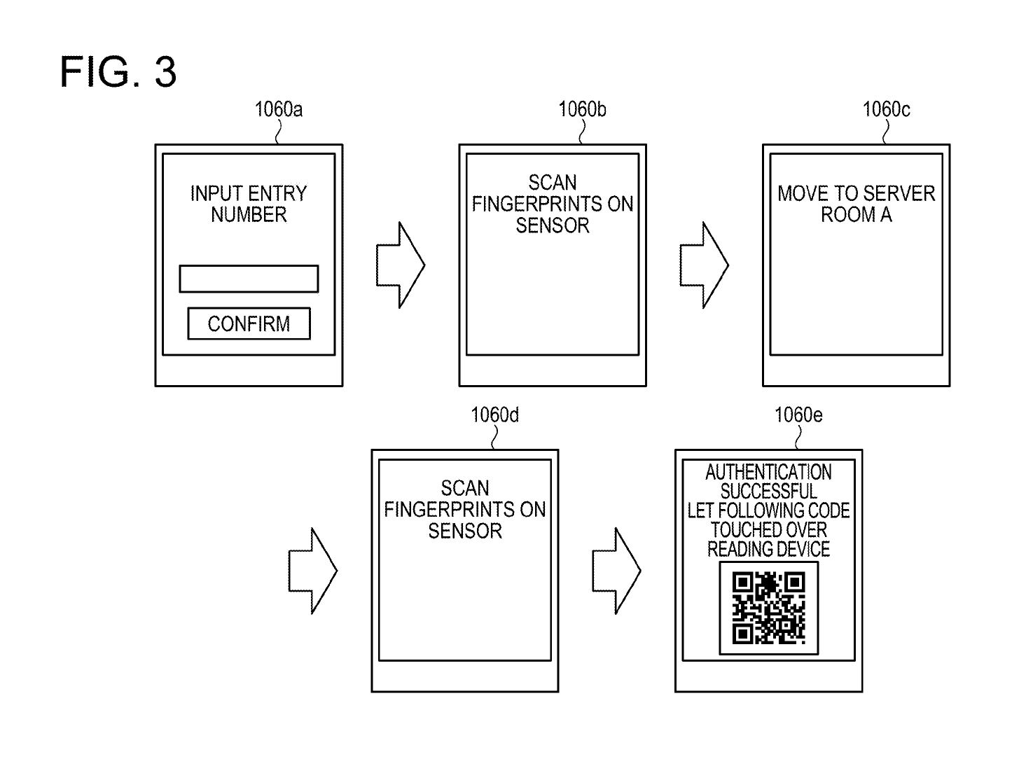

Referring back to FIG. 1, the user 1050a borrows the terminal device 100a from the reception 1010 when entering the data center 1000. At this time, the terminal device 100a requests the user 1050a to input the entry number issued in <2. Entry Number Issuance> of FIG. 2. FIG. 3 is a view illustrating an example of screen shift of the terminal device in Embodiment 1. As illustrated in FIG. 3, the terminal device 100a displays an entry number input screen 1060a for requesting the user 1050a borrowing the terminal device 100a to input the entry number. Upon receiving the input of the entry number, the terminal device 100a displays a fingerprint recognition screen 1060b for requesting recognition of the pre-registered biometric information of the user 1050a such as the fingerprints. When the biometric information is recognized, the terminal device 100a transmits the input entry number and the recognized fingerprints to the gate management server 200.

As indicated in <3. Transmission of Entry Number and Biometric Information> of FIG. 2, the gate management server 200 receives the entry number and the biometric information transmitted from the terminal device 100a. The gate management server 200 determines whether the pre-registered biometric information matches the biometric information received from the terminal device 100a, and transmits the determination result to the terminal device 100a.

As indicated in <4. Transmission of Authentication Success Information> of FIG. 2, when information indicating biometric authentication success is received from the gate management server 200, the terminal device 100a stores the recognized biometric information. Further, the terminal device 100a displays an entering instruction screen 1060c for instructing entering, for example, a server room which the user is permitted to enter. In the present embodiment, it is assumed that the user 1050 is permitted to enter a server room A among server rooms A to C of the data center 1000.

Next, the user 1050a holding the terminal device 100b displaying the entering instruction screen 1060c passes through the gate 1020 and approaches the gate 1030 of the server room A. When the terminal device 100c held by the user 1050c passing through the gate 1020 enters a communication range 1036 of the gate 1030, the terminal device 100c receives an activation instruction signal of a biometric authentication function from the gate terminal 300 of the gate 1030 (<5. Instruction of Authentication> of FIG. 2).

Upon receiving the activation instruction signal of the biometric authentication function in the communication range 1036 of the gate 1030, the terminal device 100d displays a screen 1060d for requesting authentication of the biometric information of the user 1050d such as the fingerprints. When the biometric information is recognized, the terminal device 100d executes an authentication process using the biometric information stored at the time of borrowing the terminal device 100 and the recognized biometric information (<6. Authentication Process> in FIG. 2).

When the authentication process of the biometric information is successful, the terminal device 100d displays an authentication code display screen 1060e including a code readable by the gate terminal 300 (<7. Output of Authentication Result> in FIG. 2). The user 1050d causes the displayed code to be read by the gate terminal 300 to unlock the gate 1030 so that the user 1050d may enter the server room A (<8. Unlocking of Gate> of FIG. 2).

### Function Blocks

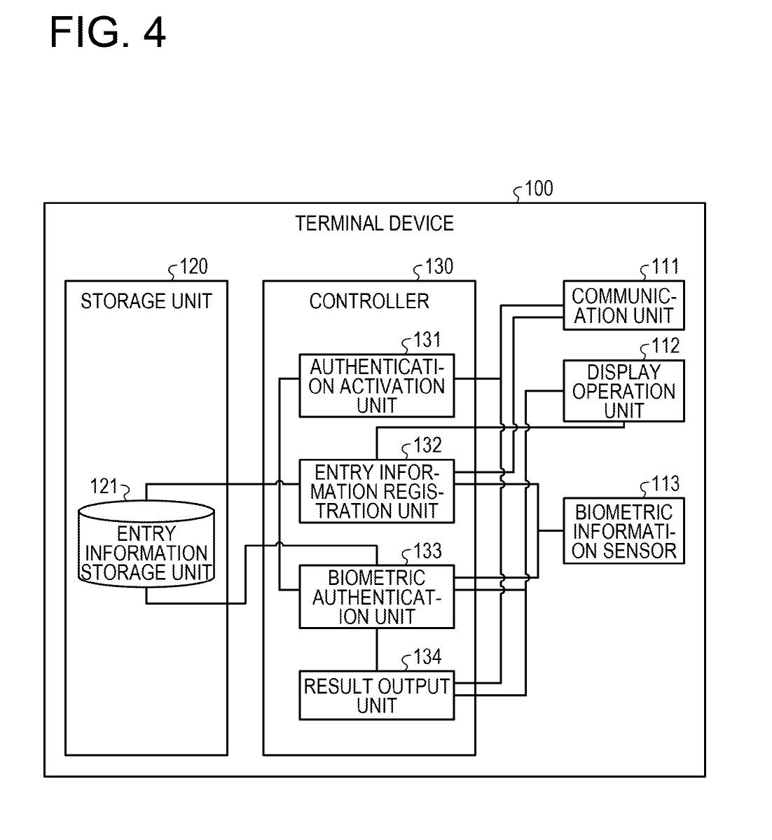

Next, the terminal device 100 and the gate management server 200 in the present embodiment will be described with reference to FIGS. 4 to 7. FIG. 4 is a diagram illustrating an example of the terminal device according to Embodiment 1. As illustrated in FIG. 4, the terminal device 100 according to the present embodiment includes a communication unit 111, a display operation unit 112, a biometric information sensor 113, a storage unit 120, and a controller 130.

The communication unit 111 controls the communication with other computers such as the gate management server 200 and the gate terminal 300 via a network (not illustrated), regardless of whether the communication is a wired or wireless communication.

The display operation unit 112 serves as an input device for receiving various operations from the user of the terminal device 100 and a display device for displaying various pieces of information. The display operation unit 112 is implemented by, for example, a touch panel in which the input device and the display device are integrated with each other. In addition, the display operation unit 112 may be implemented by an input device such as a keyboard or a mouse, and a display device such as a liquid crystal display. The display operation unit 112 outputs an operation input by the user as operation information to the controller 130. Further, the display operation unit 112 displays various screens such as the entry number input screen 1060a and the authentication code display screen 1060e output from the controller 130.

The biometric information sensor 113 recognizes the biometric information such as the fingerprints, the voiceprints, the vein pattern, or the iris pattern. The biometric information sensor 113 is implemented by, for example, a known camera, microphone, or infrared sensor.

The storage unit 120 stores, for example, various data such as programs executed by the controller 130. Further, the storage unit 120 includes an entry information storage unit 121. The storage unit 120 corresponds to a semiconductor memory device such as a random access memory (RAM), a read only memory (ROM) or a flash memory, or a storage device such as a hard disk drive (HDD).

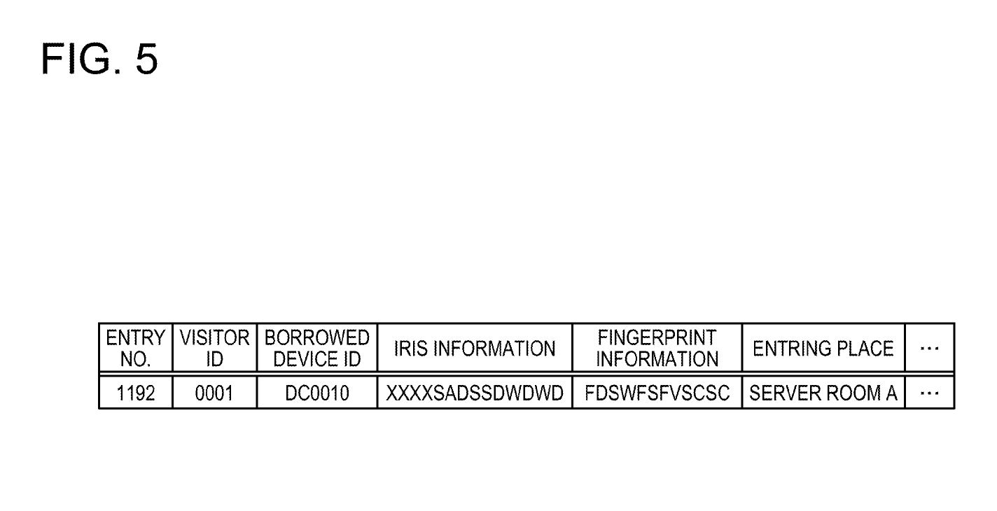

The entry information storage unit 121 stores information used for unlocking a gate. FIG. 5 is a view illustrating an example of the entry information storage unit according to Embodiment 1. As illustrated in FIG. 5, the entry information storage unit 121 stores “Visitor ID,” “Borrowed Device ID,” “Iris Information,” “Fingerprint Information,” and “Entering Place” in association with “Entry No.” The information stored in the entry information storage unit 121 is input by the user 1050.

In FIG. 5, the “Borrowed Device ID” is information assigned to each terminal device 100 for uniquely identifying the terminal device 100. The “Iris Information” and the “Fingerprint Information” store information about the iris pattern and the fingerprints recognized from the visitor corresponding to the visitor ID borrowing the terminal device 100. The “Entering Place” stores an area such as the server room in the data center 1000 where the visitor corresponding to the visitor ID is permitted to enter.

Next, the controller 130 is a processor that controls the overall process of the terminal device 100. The controller 130 is implemented in the manner that programs stored in an internal storage device are executed by, for example, a central processing unit (CPU) or a micro processing unit (MPU) using the RAM as a work area. In addition, the controller 130 may be implemented by, for example, an integrated circuit such as an application specific integrated circuit (ASIC) or a field programmable gate array (FPGA). The controller 130 includes an authentication activation unit 131, an entry information registration unit 132, a biometric authentication unit 133, and a result output unit 134. The authentication activation unit 131, the entry information registration unit 132, the biometric authentication unit 133, and the result output unit 134 are an example of electronic circuits included in a processor or an example of processes executed by a processor.

The authentication activation unit 131 controls the activation and stop of the biometric authentication unit 133. The authentication activation unit 131 receives, for example, the activation instruction signal of the biometric authentication function which includes the information for uniquely identifying the gate terminal 300, from the gate terminal 300 via the communication unit 111. The authentication activation unit 131 determines whether the received activation instruction signal is a signal transmitted from the gate terminal 300 of the entering place stored in the entry information storage unit 121. For example, the authentication activation unit 131 determines whether the uniquely identifying information which is included in the received activation instruction signal is information transmitted from the gate terminal 300 of the entering place stored in the entry information storage unit 121. When it is determined that the received activation instruction signal is a signal transmitted from the gate terminal 300 of the entering place stored in the entry information storage unit 121, the authentication activation unit 131 activates the biometric authentication unit 133.

The entry information registration unit 132 registers information about the entry of the user of the terminal device 100. When the entry number is input to the entry number input screen 1060a of FIG. 3 through the display operation unit 112, the entry information registration unit 132 transmits the input entry number to the gate management server 200 via the communication unit 111. In addition, when the biometric information of the user is recognized on the fingerprint recognition screen 1060b illustrated in FIG. 3 through the biometric information sensor 113, the entry information registration unit 132 transmits the recognized biometric information to the gate management server 200 via the communication unit 111. In addition, when the authentication success information is received from the gate management server 200 via the communication unit 111, the entry information registration unit 132 stores the input entry number and the recognized biometric information in the entry information storage unit 121.

Next, the biometric authentication unit 133 acquires the biometric information through the biometric information sensor 113, and executes the biometric authentication process by referring to the entry information storage unit 121. For example, when fingerprints are acquired through the biometric information sensor 113, the biometric authentication unit 133 determines whether the acquired fingerprints match the fingerprint information stored in the entry information storage unit 121. When it is determined that the acquired fingerprints match the stored fingerprint information, the biometric authentication unit 133 outputs a result output instruction to the result output unit 134. Further, the biometric authentication unit 133 starts or stops the process according to an instruction by the authentication activation unit 131.

Next, the result output unit 134 outputs various screens through the display operation unit 112. For example, the result output unit 134 outputs the entry number input screen 1060a when the user 1050a borrows the terminal. When the authentication success information is received from the gate management server 200 via the communication unit 111, the result output unit 134 outputs the entering instruction screen 1060c.

Further, the result output unit 134 outputs information for unlocking the gate to the gate terminal 300 according to an instruction by the biometric authentication unit 133. For example, when the gate terminal 300 has a function to read QR code (registered trademark), the result output unit 134 causes the authentication code display screen 1060e including the QR code (registered trademark) to be displayed on the display operation unit 112. In addition, the result output unit 134 may transmit a gate unlocking signal which is receivable by the gate terminal 300, via the communication unit 111.

In addition, when predetermined time elapses or when unlocking of the gate is successful, the result output unit 134 stops the output of the information for unlocking the gate. For example, when 30 seconds elapse after the display of the authentication code display screen 1060e, the result output unit 134 stops the display of the authentication code display screen 1060e and causes the biometric information authentication requesting screen 1060d to be displayed again.

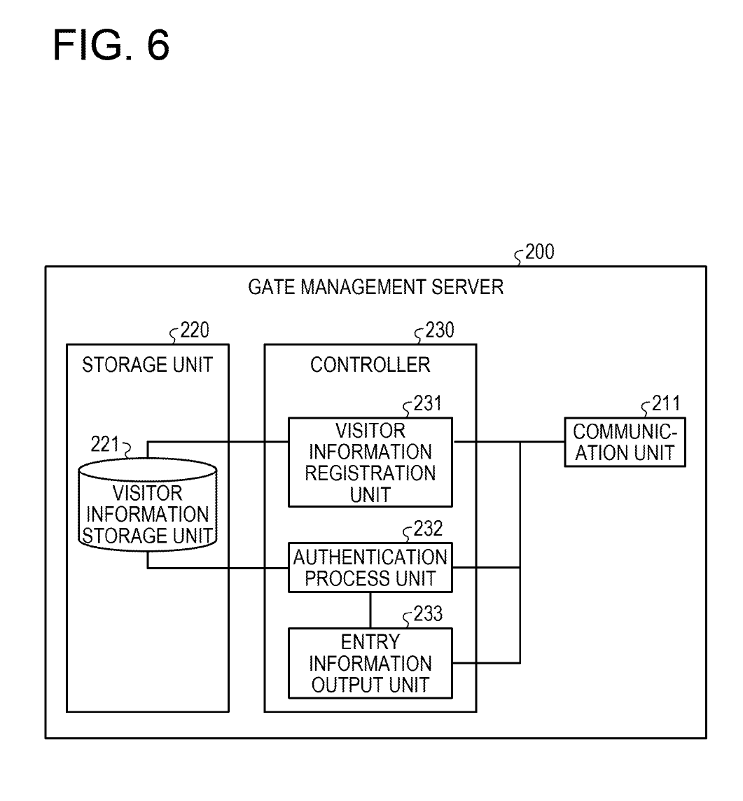

Next, the function of the gate management server 200 in the present embodiment will be described. FIG. 6 is a diagram illustrating an example of the gate management server according to Embodiment 1. As illustrated in FIG. 6, the gate management server 200 in the present embodiment includes a communication unit 211, a storage unit 220, and a controller 230.

The communication unit 211 controls a communication with other computers such as the terminal device 100, the gate terminal 300, and the entry application terminal 400 via a network (not illustrated), regardless of whether the communication is a wired or wireless communication.

The storage unit 220 stores, for example, various data such as programs executed by the controller 230. Further, the storage unit 220 has a visitor information storage unit 221. The storage unit 220 corresponds to a semiconductor memory element such as a RAM, a ROM or a flash memory, or a storage device such as an HDD.

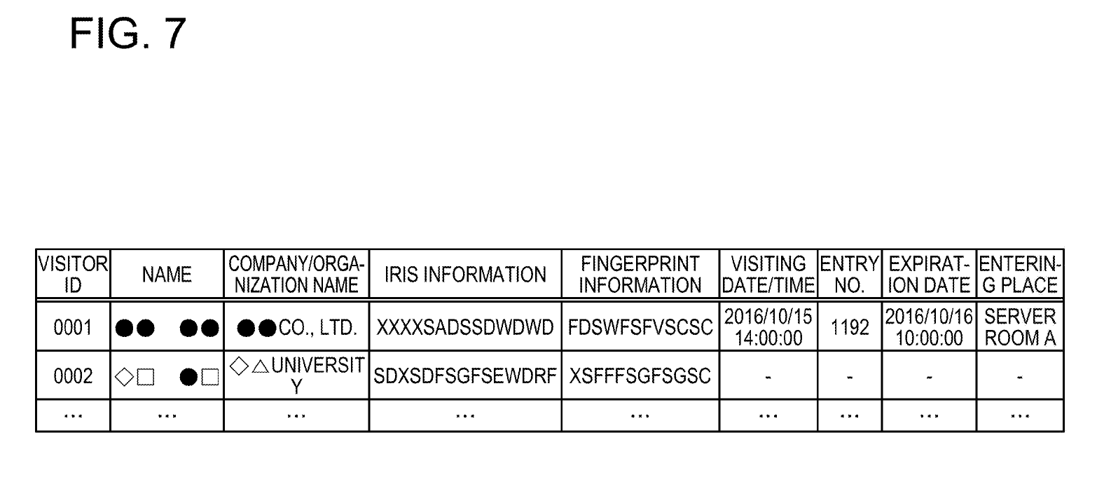

The visitor information storage unit 221 stores information used for unlocking the gate. FIG. 7 is a view illustrating an example of the visitor information storage unit according to Embodiment 1. As illustrated in FIG. 7, the visitor information storage unit 221 stores “Name,” “Company/Organization Name,” “Iris Information,” and “Fingerprint Information” in association with the “Visitor ID.” Further, the visitor information storage unit 221 additionally stores “Visiting Date/Time,” “Entry No.,” “Expiration Date,” and “Entering Place” in association with the “Visitor ID.” In addition, the information stored in the visitor information storage unit 221 is input by the entry application terminal 400 illustrated in FIG. 2.

In FIG. 7, “Name” and “Company/Organization Name” store the name of the visitor corresponding to the visitor ID and the organization to which the visitor belongs. The “Iris Information” and the “Fingerprint Information” store information about the iris pattern and the fingerprints of the visitor corresponding to the visitor ID.

In FIG. 7, “Visit Date/Time” and “Entering Place” store date/time when the visitor corresponding to the visitor ID receives the entry permission and the area such as the server room which the visitor is permitted to enter. The “Expiration Date” stores an expiry date by which the authentication of the visitor corresponding to the visitor ID is valid, that is, a closing date of a time period during which the visitor is permitted to enter the “Entering Place.”

Next, the controller 230 is a processor that controls the overall process of the gate management server 200. The controller 230 is implemented in the manner that programs stored in an internal storage device are executed by, for example, a CPU or a MPU using the RAM as a work area. In addition, the controller 230 may be implemented by an integrated circuit such as an ASIC or an FPGA. The controller 230 includes a visitor information registration unit 231, an authentication process unit 232, and an entry information output unit 233. In addition, the visitor information registration unit 231, the authentication process unit 232, and the entry information output unit 233 are an example of electronic circuits included in the processor or an example of processes executed by the processor.

The visitor information registration unit 231 acquires information about the visitor in advance and stores the information in the visitor information storage unit 221. The visitor information registration unit 231 acquires the information about the visitor which includes the biometric information from, for example, the entry application terminal 400 via the communication unit 211, and stores the information in the visitor information storage unit 221. Further, the visitor information registration unit 231 issues an entry number to the visitor and stores the entry number in the visitor information storage unit 221.

The authentication process unit 232 acquires the biometric information and executes the authentication process. When the biometric information such as the fingerprints or the iris pattern is acquired from, for example, the terminal device 100 via the communication unit 211, the authentication process unit 232 compares the biometric information with the fingerprint information or the iris information stored in the visitor information storage unit 221. The authentication process unit 232 determines whether the acquired biometric information matches the stored biometric information, and outputs the determination result to the entry information output unit 233.

Next, upon receiving the determination result of the authentication process from the authentication process unit 232, the entry information output unit 233 transmits information indicating success or failure of the authentication process to the terminal device 100. For example, when information indicating success of the authentication process is output, the entry information output unit 233 transmits authentication success information to the terminal device 100 via the communication unit 211. For example, when it is determined that the acquired biometric information does not match the stored biometric information, the entry information output unit 233 may transmit information indicating failure of the authentication.

### Process Flow

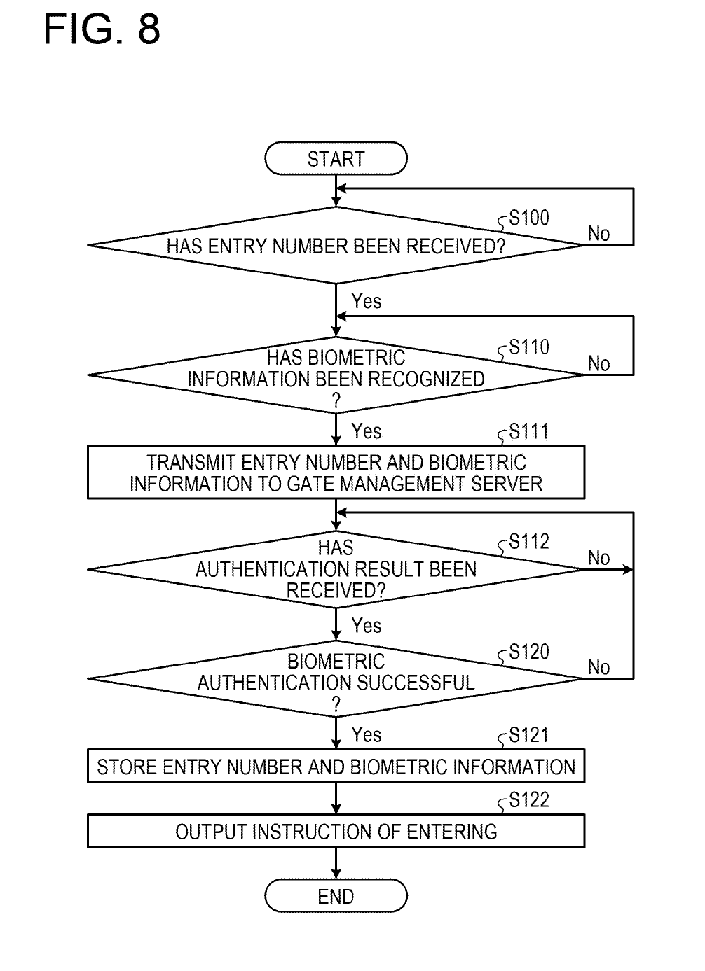

Next, a flow of the processes in the present embodiment will be described with reference to FIGS. 8 to 10. FIG. 8 is a flowchart illustrating an example of an entry registration process by the terminal device in Embodiment 1. As illustrated in FIG. 8, the result output unit 134 of the terminal device 100 causes, for example, the entry number input screen 1060a to be displayed on the display operation unit 112, and waits until input of the entry number is received from a user (not illustrated) through the display operation unit 112 (S100: “No”). When it is determined that the input of the entry number has been received (S100: “Yes”), the result output unit 134 causes, for example, the fingerprint recognition screen 1060b to be displayed on the display operation unit 112, and waits until the biometric information such as the fingerprints is recognized through the biometric information sensor 113 (S110: “No”).

Next, when it is determined that the user's biometric information has been recognized (S110: “Yes”), the entry information registration unit 132 transmits the input entry number and the recognized biometric information to the gate management server 200 via the communication unit 111 (S111). Then, the entry information registration unit 132 waits until the authentication result is received from the gate management server 200 (S112: “No”).

When the authentication result is received from the gate management server 200 (S112: “Yes”), the entry information registration unit 132 determines whether the received result is authentication success information indicating success of the biometric authentication (S120). When it is determined that the received result is not the authentication success information (S120: “No”), the entry information registration unit 132 returns to S112 to repeat the process.

Meanwhile, when it is determined that the received result is the authentication success information (S120: “Yes”), the entry information registration unit 132 stores the entry number and the biometric information in the entry information storage unit 121 (S121). Then, the result output unit 134 outputs the entering instruction screen 1060c through the display operation unit 112 (S122), and ends the entry registration process.

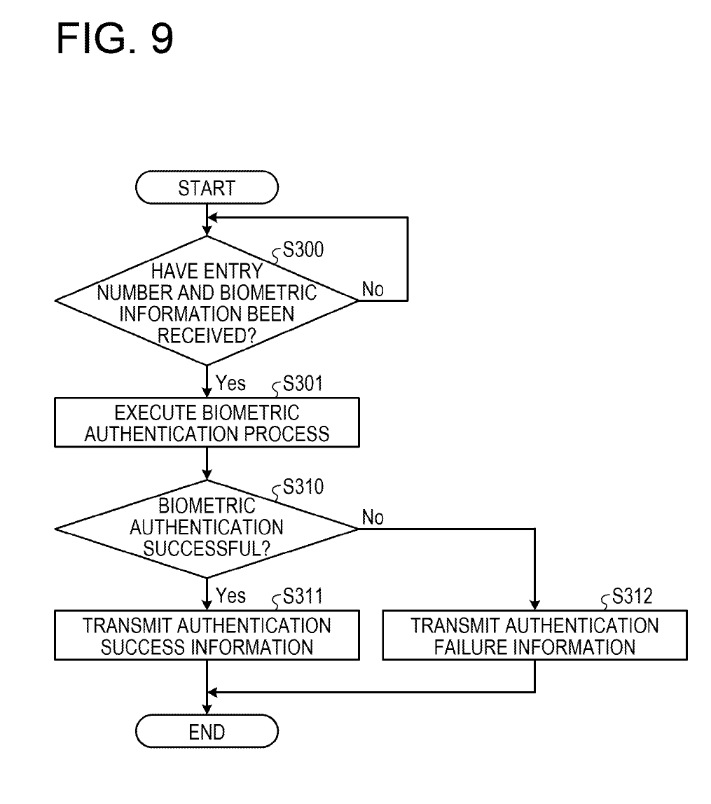

Next, a flow of an entry registration process by the gate management server 200 will be described. FIG. 9 is a flowchart illustrating an example of the entry registration process by the gate management server according to Embodiment 1. First, the authentication process unit 232 of the gate management server 200 waits until the entry number and the biometric information are received from the terminal device 100 (S300: “No”). When it is determined that the entry number and the biometric information have been received from the terminal device 100 (S300: “Yes”), the authentication process unit 232 executes the biometric authentication process by referring to the biometric information corresponding to the entry number, such as the fingerprint information, which is stored in the visitor information storage unit 221 (S301).

Next, the authentication process unit 232 determines whether the biometric authentication process is successful (S310). When it is determined that the biometric authentication process is successful (S310: “Yes”), the authentication process unit 232 transmits authentication success information to the terminal device 100 (S311). Meanwhile, when it is determined that the biometric authentication process is failed (S310: “No”), the authentication process unit 232 transmits authentication failure information to the terminal device 100 (S312).

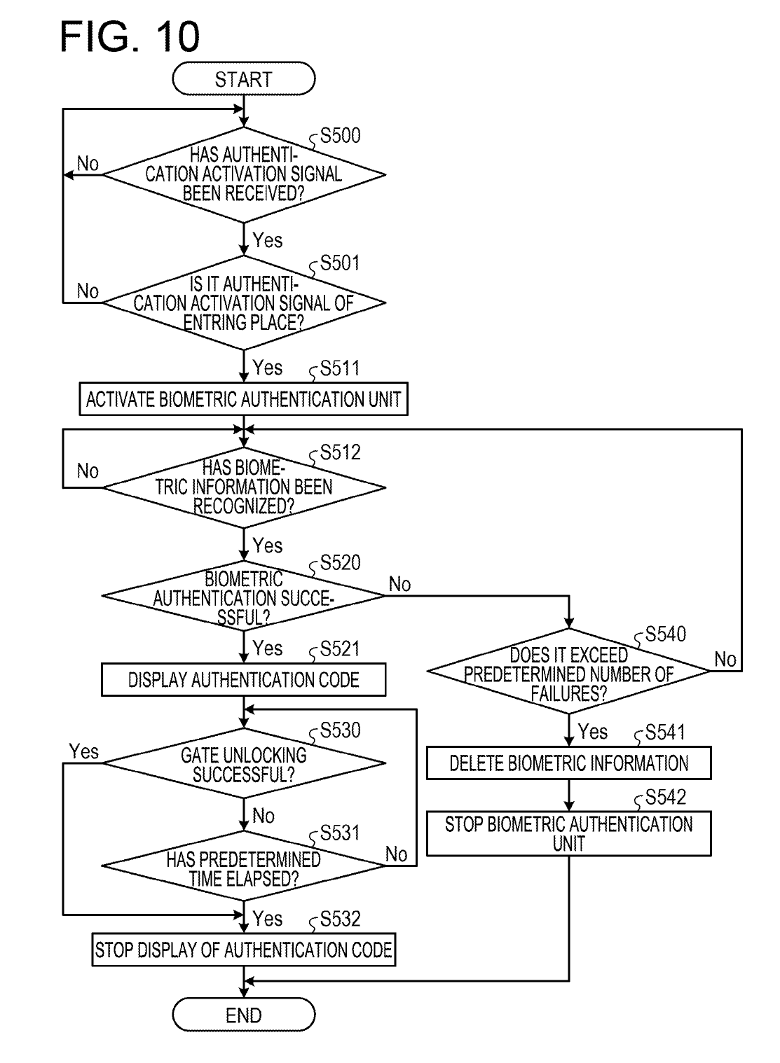

Next, a flow of an entry authentication process by the terminal device 100 that has completed the entry registration process will be described. FIG. 10 is a flowchart illustrating an example of the entry authentication process by the terminal device according to Embodiment 1. First, the authentication activation unit 131 of the terminal device 100 waits until an authentication activation signal is received from the gate terminal 300 via the communication unit 111 (S500: “No”).

When it is determined that the authentication activation signal has been received from the gate terminal 300 (S500: “Yes”), the authentication activation unit 131 refers to the entry information storage unit 121 and determines whether the received authentication activation signal is a signal transmitted from the gate terminal 300 of the entering place (S501). When it is determined that the received authentication activation signal is not a signal transmitted from the gate terminal 300 of the entering place (S501: “No”), the authentication activation unit 131 returns to S500 to repeat the process.

When it is determined that the received authentication activation signal is a signal transmitted from the gate terminal 300 of the entering place (S501: “Yes”), the authentication activation unit 131 activates the biometric authentication unit 133 (S511). The biometric authentication unit 133 waits until the biometric information such as the fingerprints is recognized through the biometric information sensor 113 (S512: “No”).

When the biometric information is recognized (S512: “Yes”), the biometric authentication unit 133 determines whether the recognized biometric information matches the biometric information stored in the entry information storage unit 121 (S520). When it is determined that the biometric information matches each other (S520: “Yes”), the result output unit 134 causes an authentication code readable by the gate terminal 300 to be displayed through the display operation unit 112 (S521).

Next, the result output unit 134 determines whether information indicating success of gate unlocking has been received from the gate terminal 300 via the communication unit 111 (S530). When it is determined that the information indicating success of gate unlocking has been received (S530: “Yes”), the result output unit 134 stops the display of the authentication code (S532) and ends the entry authentication process.

Meanwhile, when it is determined that the information indicating success of gate unlocking has not been received (S530: “No”), the result output unit 134 determines whether predetermined time has elapsed after the start of the display of the authentication code (S531).

When it is determined that the predetermined time has elapsed after the start of the display of the authentication code (S531: “Yes”), the result output unit 134 stops the display of the authentication code (S532) and ends the entry authentication process. Meanwhile, when it is determined that the predetermined time has not elapsed after the start of the display of the authentication code (S531: “No”), the process returns to S530 to repeat the process.

Referring back to S520, when it is determined that the biometric information does not match each other (S520: “No”), the biometric authentication unit 133 determines whether the number of times of failures in the biometric authentication process exceeds a predetermined number (S540). When it is determined that the number of times of failures in the biometric authentication process does not exceed a predetermined number (S540: “No”), the biometric authentication unit 133 returns to S512 to repeat the process.

Meanwhile, when it is determined that the number of times of failures in the biometric authentication process exceeds a predetermined number (S540: “Yes”), the biometric authentication unit 133 deletes the biometric information stored in the entry information storage unit 121 (S541). Then, the biometric authentication unit 133 stops the biometric authentication process (S542) and ends the process.

### Effects

As described above, in the present embodiment, the terminal device having the biometric authentication unit that executes the biometric authentication process further includes the authentication activation unit that activates the biometric authentication unit when it is detected that the terminal device approaches a predetermined entering/leaving management device. In addition, the terminal device further includes the result output unit that outputs authentication information readable by the predetermined entering/leaving management device when it is determined that the biometric authentication process in the biometric authentication unit is successful. Thus, the biometric authentication process may be introduced at relatively lower costs.

In addition, in a case where the terminal device of the present embodiment is used, it is unnecessary to replace the device itself on the side of the gate of the data center even when it is attempted to adopt the biometric authentication technology based on other physical characteristics. Thus, the replacement costs may be reduced.

In addition, in the present embodiment, it may be detected that the terminal device approaches the predetermined entering/leaving management device, when a predetermined signal is received from the predetermined entering/leaving management device. Thus, it is possible to enable the authentication function by specifying that the user holding the terminal device approaches the gate where the user is permitted to enter.

In addition, the terminal device of the present embodiment may display the code readable by the entering/leading management device. Thus, it is possible to provide the authentication method according to the entering/leaving management device on the side of the gate, so that the biometric authentication process may be introduced at relatively lower costs without replacing the entering/leaving management device.

### Embodiment 2

Although an embodiment of the present disclosure has been described, the present disclosure may be implemented in various different forms, in addition to the embodiment described above. For example, the configuration to detect that the terminal device 100 approaches the gate terminal 300 is an example, and position information may be detected using a global positioning system (GPS) or the like to be compared with position information of the gate terminal 300.

In addition, the authentication code output by the result output unit 134 of the terminal device 100 is stored in advance in, for example, the storage unit 120 and read when the authentication success information is received from the gate management server 200. However, the present disclosure is not limited to this embodiment. For example, the authentication code may be stored in the storage unit 220 of the gate management server 200, and the entry information output unit 233 may transmit the authentication code along with the authentication success information. In addition, the gate terminal 300 may generate an authentication code having a time limit for use each time, and the entry information output unit 233 may acquire the authentication code from the gate terminal 300 via the communication unit 211. With this configuration, it is possible to suppress the security deterioration caused from leakage of the authentication code.

In addition, in the embodiment described above, the gate terminal 300 may be configured not to output the authentication activation signal at all times. For example, the gate terminal 300 may be configured to start outputting the authentication activation signal when the visiting date/time stored in the visitor information storage unit 221 comes, or predetermined time elapses after the visitor's entry. In addition, the gate terminal 300 may be configured to start outputting the authentication activation signal when it is detected that the terminal device 100 approaches, by using a GPS (not illustrated), images captured by a monitoring camera, or a sensor. In addition, the gate terminal 300 may be configured to stop outputting the authentication activation signal, for example, when predetermined time elapses after the start of the output of the authentication activation signal, when the gate unlocking is successful, or when the terminal device 100 leaves the periphery of the gate terminal 300. In addition to starting and stopping the output of the authentication activation signal, the gate terminal 300 may start or stop the function to read the authentication code in the same manner as that described above. Thus, the power consumption by the gate terminal 300 may be suppressed.

### System

In addition, among the processes described in the present embodiment, all or some of the processes described to be automatically executed may be manually executed. Alternatively, all or some of the processes described to be manually executed may be automatically executed by a known method. In addition, the process procedures, the control procedures, the specific names, and the information including various data or parameters described in the disclosure herein or the drawings may be arbitrarily changed unless otherwise specified.

In addition, each component of the respective illustrated devices is functionally conceptual and is not necessarily required to be configured physically as illustrated. That is, specific forms of distribution or integration of the respective devices are not limited to those illustrated. All or some of the devices may be configured to be functionally or physically distributed or integrated in arbitrary units depending on, for example, various loads or use conditions. In addition, all or some of the respective process functions executed in the respective devices may be implemented by a CPU and programs analyzed and executed in the CPU, or hardware by a wired logic.

### Hardware Configuration

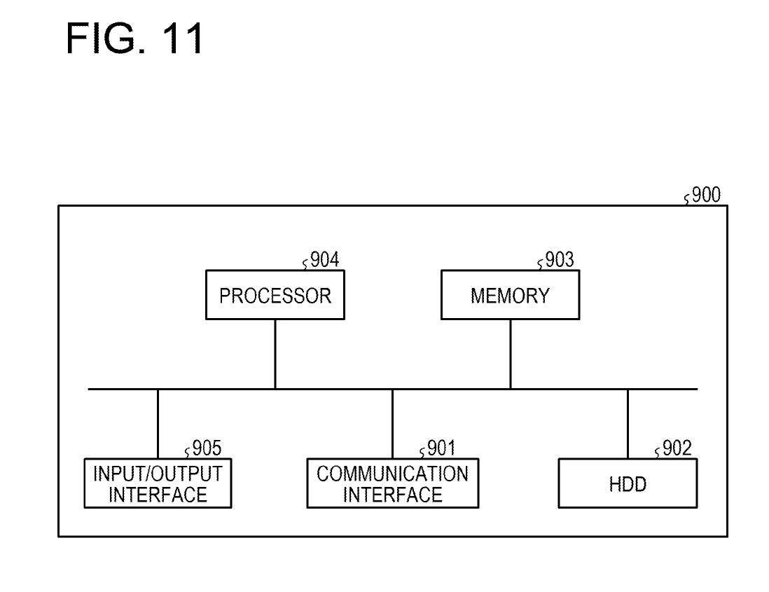

The various processes described in the embodiments above may be implemented by causing a computer to execute programs prepared in advance. Thus, hereinbelow, an example of the computer executing the programs having the same functions as those in the embodiments described above will be described. FIG. 11 is a view illustrating an example of a hardware configuration of the computer. As illustrated in FIG. 11, a computer 900 includes a communication interface 901, an HDD 902, a memory 903, a processor 904, and an input/output interface 905. In the descriptions below, the terminal device 100 will be described as an example. However, the gate management server 200 may also be implemented by the same computer as described above.

The communication interface 901 corresponds to the communication unit 111 indicated when describing the respective functional units, and is, for example, a network interface card. The HDD 902 stores information such as programs or DB for operating the process units indicated when describing the respective functional units.

The processor 904 reads the programs for executing the same processes as the respective process units indicated when describing the respective functional units, from the HDD 902 or the like, and develops the programs in the memory 903 so as to operate the processes of executing the respective functions described in FIG. 4 and others. That is, the processes execute the same functions as the authentication activation unit 131, the entry information registration unit 132, the biometric authentication unit 133, and the result output unit 134 of the terminal device 100. The input/output interface 905 corresponds to the display operation unit 112 and the biometric information sensor 113 that are indicated when describing the respective functional units.

As described above, the terminal device 100 operates as an information processing device that executes the gate management method, by reading and executing the programs. In addition, the terminal device 100 may implement the same functions as those in the embodiments described above by reading the programs from a recording medium by using a medium reading device and executing the read programs. In addition, the programs described in the embodiments are not limited to the programs executed by the terminal device 100. For example, the present disclosure may also be applied to a case where another computer or server executes the programs, or a case where a computer and a server cooperatively execute the programs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal device that executes a biometric authentication process, the terminal device comprising:
a memory; and
a processor coupled to the memory and the processor configured to:
activate the biometric authentication process when the terminal device is detected to approach a predetermined entering/leaving management device; and
output authentication information readable by the predetermined entering/leaving management device when the biometric authentication process is determined to be successful.

2. The terminal device according to claim 1, wherein when a predetermined signal is received from the predetermined entering/leaving management device, the processor detects that the terminal device approaches the predetermined entering/leaving management device.

3. The terminal device according to claim 1, wherein when position information of the terminal device is acquired, and the position information indicates that the terminal device is within a predetermined range from the predetermined entering/leaving management device, the processor detects that the terminal device approaches the predetermined entering/leaving management device.

4. The terminal device according to claim 1, wherein the processor causes a code readable by the predetermined entering/leaving management device to be displayed.

5. The terminal device according to claim 1, wherein the processor stops displaying the readable code when predetermined time elapses.

6. The terminal device according to claim 1, wherein the processor outputs a signal which is receivable by the predetermined entering/leaving management device to execute the biometric authentication process, before the predetermined time elapses.

7. The terminal device according to claim 1, further comprising:
a biometric information sensor configured to acquire biometric information of a user of the terminal device,
wherein the processor is further configured to transmit the biometric information of the user of the terminal device which is acquired by the biometric information sensor, to a gate management server along with information about the user of the terminal device, and receive information about an entering place of the user of the terminal device from the gate management server.

8. A non-transitory computer-readable recording medium having stored therein a gate management program for causing a computer to execute a biometric authentication process, the process comprising:
activating the biometric authentication process when a terminal device is detected to approach a predetermined entering/leaving management device; and
outputting authentication information readable by the predetermined entering/leaving management device when the biometric authentication process is determined to be successful.

9. A gate management system, comprising:
a terminal device; and
a gate management server,
wherein the terminal device includes:
a biometric information sensor configured to acquire biometric information of a user of the terminal device;
a first memory; and
a first processor coupled to the first memory and the first processor configured to:
transmit the biometric information of the user of the terminal device, to the gate management server along with information about the user of the terminal device, and receive information about an entering place of the user of the terminal device from the gate management server;
activate a first biometric authentication process when the terminal device is detected to approach the entering/leaving management device specified in the information about the entering place;
output authentication information readable by the entering/leaving management device when the first biometric authentication process is determined to be successful, and
the gate management server includes:
a second memory; and
a second processor coupled to the second memory and the second processor configured to:
execute a second biometric authentication process when the biometric information and the information about the user of the terminal device are received from the terminal device; and
transmit information about an entering place corresponding to the information about the user of the terminal device to the terminal device when the second biometric authentication process is determined to be successful.
